(19) United States
(12) Patent Application Publication
(10) Pub. No.: US 2026/0323786 A1
(43) Pub. Date: Oct. 15, 2026

(54) INDUCTION COOKING APPLIANCE

(71) Applicant: Haier US Appliance Solutions, Inc., Wilmington, DE (US)

(72) Inventor: Eugenio Gomez, Louisville, KY (US)

(21) Appl. No.: 19/174,198

(22) Filed: Apr. 9, 2025

(51) Int. Cl. H05B 6/06; H05B 6/12

(52) U.S. Cl. CPC H05B 6/062; H05B 6/1209; H05B 2213/07

(57) ABSTRACT

A cooking appliance includes an induction burner assembly that has a center. The induction burner assembly generates a magnetic field. An offset thermistor is positioned within the magnetic field generated by the induction burner assembly. The offset thermistor is positioned radially offset from the center of the induction burner assembly. A magnetic lead coupled with the offset thermistor. The magnetic lead is heated by the magnetic field generated by the induction burner assembly. The magnetic lead heated by the magnetic field heats the offset thermistor. A controller is communicatively coupled with the induction burner assembly and the offset thermistor. The magnetic lead allows the controller to be communicatively coupled with the offset thermistor.

### FIELD OF THE INVENTION

The present subject matter relates generally to cooking appliances, and more particularly to induction systems for cooking appliances.

### BACKGROUND OF THE INVENTION

Closed-loop cooking for cooking appliances requires a temperature control method, such as PID (proportional, integral, derivative) control. PID control adjusts power to a burner, for example, based on a cookware temperature. Ideally, a target temperature used as input to the controller matches the cookware temperature. However, due to design constraints (e.g., space between a cooktop and a temperature sensor), direct measurement is not always feasible. As such, current systems may rely on an inferred cookware temperature, which may be inaccurate or delayed.

Current induction cooking appliances may use a thermistor temperature sensor to monitor cooktop component temperatures. The thermistor may be positioned beneath a cooktop glass. Such a placement of the thermistor introduces significant time delays and inaccuracies when used to measure the cookware temperature. As such, current systems may not be able to provide precise temperature control needed for closed-loop cooking. Despite this limitation, manufacturers may accept such a tradeoff to maintain a smooth glass surface without a protruding temperature sensor.

A more effective solution that would avoid trading off between a smooth cooktop and accurately sensing the cookware temperature is needed. Accordingly, a cooking appliance and system of operating a cooking appliance that obviates one or more of the above-mentioned drawbacks would be desirable. In particular, a cooking appliance capable of accurately estimating the cookware temperature would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance includes an induction burner assembly that has a center. The induction burner assembly generates a magnetic field. A thermistor is positioned within the magnetic field generated by the induction burner assembly. The thermistor is positioned radially offset from the center of the induction burner assembly. A magnetic lead coupled with the thermistor. The magnetic lead is heated by the magnetic field generated by the induction burner assembly. The magnetic lead heated by the magnetic field heats the thermistor. A controller is communicatively coupled with the induction burner assembly and the thermistor. The magnetic lead allows the controller to be communicatively coupled with the thermistor.

In another exemplary aspect of the present disclosure, a closed-loop control system is for a cooking appliance. The closed-loop control system includes an induction burner assembly that has a center. The induction burner assembly generates a magnetic field. A thermistor is positioned within the magnetic field generated by the induction burner assembly. The thermistor is positioned radially offset from the center of the induction burner assembly. A magnetic lead is coupled with the thermistor. The magnetic lead is heated by the magnetic field generated by the induction burner assembly. The magnetic lead heated by the magnetic field heats the thermistor. A controller communicatively coupled with the induction burner assembly and the thermistor. The magnetic lead allows the controller to be communicatively coupled with the thermistor. The controller is configured to activate the induction burner assembly and direct power to the induction burner assembly based on a temperature sensed by the thermistor.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to example embodiments of the present disclosure.

FIG. 2 provides schematic view of an example induction burner assembly of the example cooking appliance of FIG. 1.

FIG. 3 provides another schematic view of the example induction burner assembly having a heat map according to example embodiments of the present disclosure.

FIG. 4 provides a graph illustrating a comparison of a sensor temperature, a cookware temperature, a cooktop temperature, and a target temperature over time, according to example embodiments of the present disclosure.

FIG. 5 provides a zoomed-in view of a thermistor having a magnetic lead surplus according to example embodiments of the present disclosure.

FIG. 6 provides another zoomed-in view of an example thermistor having a magnetic feature example according to example embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

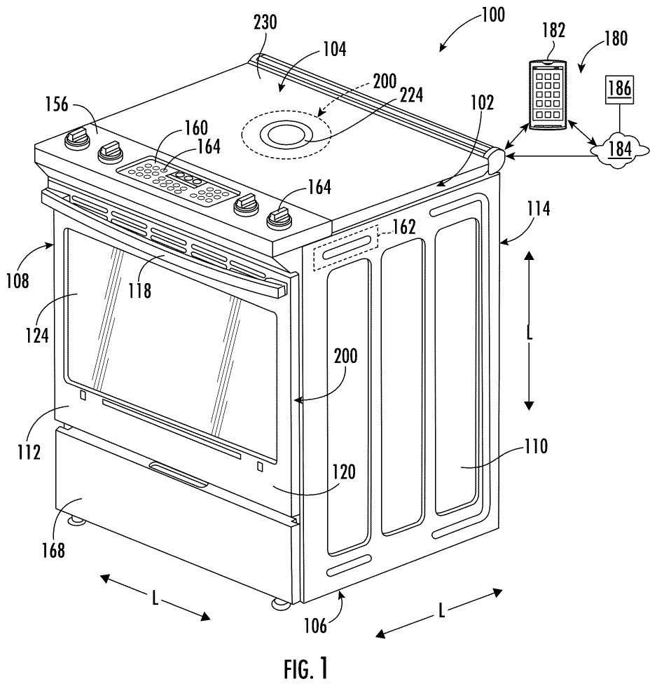

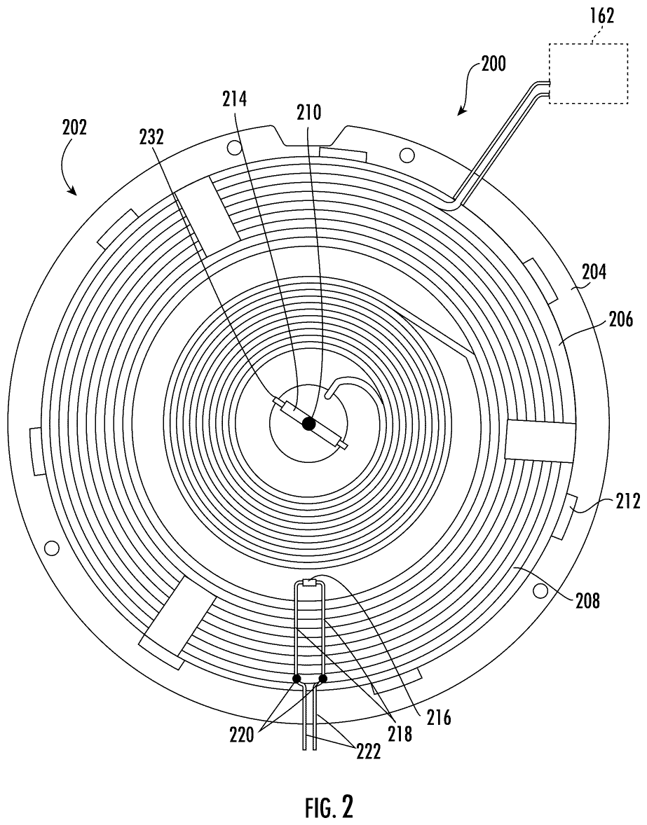

FIG. 1 provides a perspective view of a cooking appliance 100, including a cooktop 102, and FIG. 2 provides a similar view of the cooking appliance 100. Cooking appliance 100 is provided by way of example only and is not intended to limit the present subject matter to the arrangement shown in FIGS. 1 and 2. Thus, the present subject matter may be used with other cooking appliance 100 and/or cooktop 102 configurations, e.g., double oven range appliances, or an oven. As illustrated, cooking appliance 100 generally defines a vertical direction V, a lateral direction L, and a transverse direction T, each of which is mutually perpendicular, such that an orthogonal coordinate system is generally defined.

The cooking appliance 100 includes a closed-loop control system 200. The system 200 of the cooking appliance 100 includes a plurality of induction burner assemblies 202, or heating elements. For the embodiment depicted, cooking appliance 100 includes at least one induction burner assembly 202 positioned vertically underneath a panel 230, or glass panel, of the cooktop 102. Induction burner assemblies 202 may be electric heating elements. In certain embodiments, the cooking appliance 100 is a radiant cooktop with resistive heating elements or coils mounted below cooktop 102. However, in other embodiments, the cooking appliance 100 includes other suitable shape, configuration, and/or number of induction burner assemblies 202, for example, the cooking appliance 100 may be an open coil cooktop with induction burner assemblies 202 also positioned below the panel 230 of the cooktop 102. Each of the induction burner assemblies 202 may be the same type of heating element, or the cooking appliance 100 may include a combination of different types of induction heating elements.

As mentioned, induction burner assembly 202 may be an induction style heating element. Thus, as would be understood by those skilled in the art, cooking appliance 100 may supply a current to induction burner assembly 202 (e.g., such as a Lenz coil). The induction burner assembly 202 may include a bracket 204 that retains the induction burner assembly 202 in place relative to the cooking appliance 100. The induction burner assembly 202 may further include an insulation layer 206 coupled with the bracket 204. The insulation layer 206 may be made from mica, for example, among other insulative materials. The induction burner assembly 202 may further include a coil 208 coupled with the bracket 204 or the insulation layer 206. The coil 208 being configured to generate a magnetic field. As such, current may pass through induction burner assembly 202 to generate a magnetic field. The magnetic field may be a high frequency circulating magnetic field. The magnetic field may be directed towards and through the cooking appliance 100 to the cooktop 102 or a cookware item (not shown) (e.g., a pan). In particular, when the magnetic field penetrates the panel 230, the magnetic field induces a circulating electrical current within magnetic material positioned within the magnetic field. The material properties of items such as the cookware may restrict a flow of the induced electrical current and convert the induced electrical current into heat. As the magnetic material (e.g., the cookware) heats up, contents thereon heat up as well. In such a manner, the induction heating element can cook the contents atop, or within, the cookware. Additionally, or alternatively, the induction burner assembly 202 may include at least one ferrite bar 212 configured to concentrate or direct the magnetic field generated by the coil 208.

The cookware may be placed on one or more induction burner assemblies 202 to heat the cookware and cook or heat food items placed atop the cooktop 102. The cooking appliance 100 may include a forward panel 156. The forward panel 156 may be coupled with and positioned transversely forward of the cooktop 102. The forward panel 156 may include a control panel 160 that includes user inputs, or controls 164. The cooking appliance 100 may further include a controller 162 communicatively coupled with the control panel 160 and the controls 164. The controls 164 may take the form of a knob (as illustrated in the example embodiments). Additionally, or alternatively, a display (not shown) may be positioned near the cooktop 102. The display may include the controls 164 via capacitive touch sensors, for example. The controls 164 may permit a user to make selections for cooking of food items. More specifically, the controls 164 may permit a user to set a temperature point for the cooktop 102. Although shown in front of the induction burner assemblies 202, the controls 164 may be positioned in any suitable location.

The controls 164 may include buttons, knobs, and the like, as well as combinations thereof, and/or controls 164 may be implemented on a remote user interface device such as a smartphone, or external device 182. As an example, a user may manipulate one or more controls 164 to select a temperature and/or a heat or power output for each induction burner assembly 202. The selected temperature or heat output of induction burner assembly 202 affects the heat transferred to the cooktop 102, or cookware, placed within the generated magnetic field of the induction burner assembly 202. The display may display information regarding cooking operations or inputs from a user regarding the cooking operation. The display may be any suitable display capable of providing visual feedback, such as a liquid crystal display (LCD), a light emitting diode (LED) display, a segmented display, or the like. Additionally or alternatively, display may be a touch display capable of receiving touch inputs from a user.

The cooking appliance 100 may further include or be in operative communication with a processing device or the controller 162 that may be generally configured to facilitate appliance operation. In this regard, the induction burner assemblies 202, the controls 164, and the display may be in communication with controller 162 such that controller 162 may receive control inputs from the controls 164, may display information using display, and may otherwise regulate operation of cooking appliance 100. For example, signals generated by controller 162 may operate cooking appliance 100, including any or all system components, subsystems, or interconnected devices, in response to the position of the controls 164 and other control commands. The controls 164 and other components of the cooking appliance 100 may be in communication with controller 162 via, for example, one or more signal lines or shared communication busses. In this manner, Input/Output (“I/O”) signals may be routed between controller 162 and various operational components of cooking appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 162 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 162 may include, or be associated with, a memory device or one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 162 may be operable to execute programming instructions or micro-control code associated with an operating cycle of cooking appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 162 as disclosed herein is capable of and may be operable to perform any methods, method steps, or portions of methods as disclosed herein. For example, in some embodiments, methods disclosed herein may be embodied in programming instructions stored in the memory and executed by controller 162. For example, the controller 162 may activate the induction burner assembly 202 by directing power to the induction burner assembly 202 based on a detected temperature by the offset thermistor 216 (e.g., if the detected temperature is lower than a target temperature, the controller 162 may direct more power to the induction burner assembly 202). Additionally, or alternatively, if the sensed temperature by the offset thermistor 216 is higher than the target temperature, the controller 162 may direct less power to the induction burner assembly 202. As such, the system 200 described herein may also be referred to as a closed-loop control system.

The memory devices may also store data that can be retrieved, manipulated, created, or stored by the one or more processors or portions of controller 162. The data can include, for instance, data to facilitate performance of methods described herein. The data can be stored locally (e.g., on controller 162) in one or more databases and/or may be split up so that the data is stored in multiple locations. In addition, or alternatively, the one or more database(s) can be connected to controller 162 through any suitable network(s), such as through a high bandwidth local area network (LAN) or wide area network (WAN). In this regard, for example, controller 162 may further include a communication module or interface that may be used to communicate with one or more other component(s) of appliance 100, controller 162, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring still to FIG. 1, a schematic diagram of an external communication system 180 will be described according to an exemplary embodiment of the present subject matter. In general, external communication system 180 is configured for permitting interaction, data transfer, and other communications between cooking appliance 100 and one or more external devices. For example, this communication may be used to provide and receive operating parameters, user instructions or notifications, performance characteristics, user preferences, or any other suitable information for improved performance of cooking appliance 100. In addition, it should be appreciated that external communication system 180 may be used to transfer data or other information to improve performance of one or more external devices or appliances and/or improve user interaction with such devices.

For example, external communication system 180 permits controller 162 of cooking appliance 100 to communicate with a separate device external to cooking appliance 100, referred to generally herein as an external device 182. As described in more detail below, these communications may be facilitated using a wired or wireless connection, such as via a network 184. In general, external device 182 may be any suitable device separate from cooking appliance 100 that is configured to provide and/or receive communications, information, data, or commands from a user. In this regard, external device 182 may be, for example, a personal phone, a smartphone, a tablet, a laptop or personal computer, a wearable device, a smart home system, or another mobile or remote device.

In addition, a remote server 186 may be in communication with cooking appliance 100 and/or external device 182 through network 184. In this regard, for example, remote server 186 may be a cloud-based server 186, and is thus located at a distant location, such as in a separate state, country, etc. According to an exemplary embodiment, external device 182 may communicate with a remote server 186 over network 184, such as the Internet, to transmit/receive data or information, provide user inputs, receive user notifications or instructions, interact with or control cooking appliance 100, etc. In addition, external device 182 and remote server 186 may communicate with cooking appliance 100 to communicate similar information.

In general, communication between cooking appliance 100, external device 182, remote server 186, and/or other user devices or appliances may be carried using any type of wired or wireless connection and using any suitable type of communication network, non-limiting examples of which are provided below. For example, external device 182 may be in direct or indirect communication with cooking appliance 100 through any suitable wired or wireless communication connections or interfaces, such as network 184. For example, network 184 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 180 is described herein according to an exemplary embodiment of the present subject matter. However, it should be appreciated that the exemplary functions and configurations of external communication system 180 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

With reference to FIG. 2, the cooking appliance 100 may include an offset thermistor 216 positioned adjacent to the induction burner assembly 202. Additionally, or alternatively, the induction burner assembly 202 has a center 210. The offset thermistor 216 is positioned radially offset from the center 210. For example, the offset thermistor 216 may be positioned at about half a radius away from the center, where the radius is the radius of the induction burner assembly 202. Additionally, or alternatively, a manufacturer, assembler, retailer, or designer may position the offset thermistor 216 radially offset from the center 210 based on a radius of a predicted cookware bottom size. For example, the predicted cookware bottom size may be between about 3 inches and about 15 inches, between about 5 inches and 13 inches, between about 7 inches and 11 inches, or about 9 inches. Therefore, the offset thermistor 216 may be placed between about 2 inches and about 15 inches away from the center 210, between about 3 inches and 7 inches away from the center 210, between about 4 inches and 6 inches away from the center 210, or about 5 inches away from the center 210 horizontally.

As used herein, “thermistor” or the equivalent is intended to refer to any suitable type of temperature measuring system or device positioned at any suitable location for measuring the sensor temperature. Thus, for example, offset thermistor 216 may be any suitable type of temperature measurement device, such as a thermistor, a thermocouple, a resistance temperature detector, a semiconductor-based integrated circuit temperature sensor, etc. In addition, offset thermistor 216 may be positioned at any suitable location and may output a signal, such as a voltage, to controller 162 that is proportional to, or indicative of, the sensor temperature being measured. Although example positioning of the temperature sensor is described herein, it should be appreciated that the cooking appliance 100 may include any other suitable number, type, and position of temperature or other sensors according to alternative embodiments.

With continued reference to FIG. 2, the closed-loop control system 200 for the cooking appliance 100 may include a center thermistor 214 positioned at or adjacent to the center 210 of the induction burner assembly 202. The center thermistor 214 may assist in sensing a temperature of at least one of the induction burner assembly 202 itself or the panel 230. Furthermore, the center thermistor 214 may allow the closed-loop control system 200 to incorporate redundancy related to detecting temperature of components of the system 200. Additionally, or alternatively, the center thermistor 214 may be communicatively coupled with the controller 162 via, for example, center thermistor leads 232. The center thermistor leads 232 may be positioned away from the magnetic field generated by the induction burner assembly 212. For example, the center thermistor leads 232 may extend vertically downward away from the coil 208.

Referring back to the offset thermistor 216, the magnetic lead 218 coupled with the offset thermistor 216 may be coupled with a non-magnetic lead 222 via a crimp 220, for example. Additionally, or alternatively, the magnetic lead 218 may be coupled with the non-magnetic lead 222 via welding, soldering, or other suitable coupling mechanism for two different types of leads. The non-magnetic lead 222 may be made from, for example, copper or a copper alloy. The non-magnetic lead 222 may be positioned such that a majority of the non-magnetic lead 222 is not within the magnetic field generated by the induction burner assembly 202. The non-magnetic lead 222 may further communicatively couple the offset thermistor 216 with the controller 162. For example, the controller 162 may be communicatively coupled with the offset thermistor 216 via at least the non-magnetic lead 222, the crimp 220, and the magnetic lead 218.

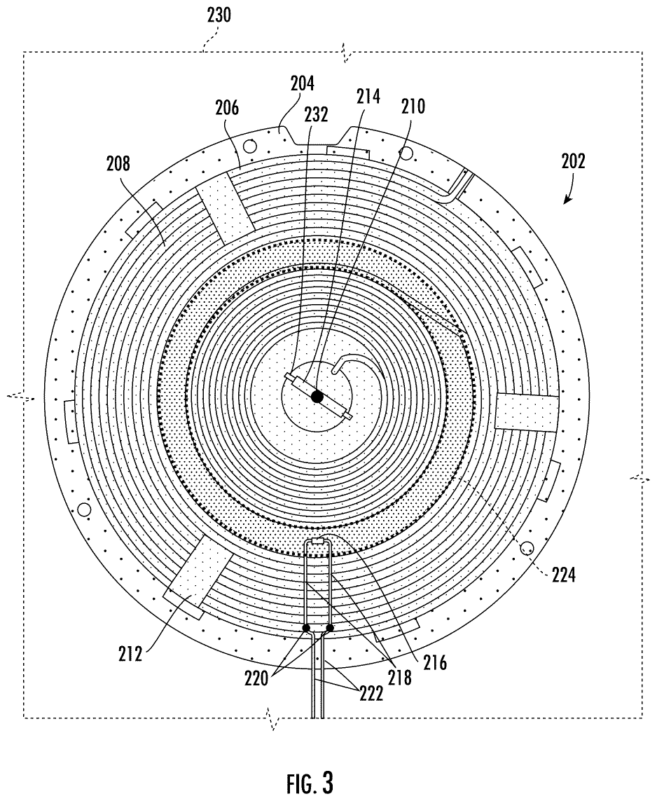

With reference to FIG. 3, the closed-loop control system 200 of the cooking appliance 100 includes the panel 230. The panel 230 is configured to support cookware during a cooking operation. The cookware may be placed on a contact area 224 defined by the panel 230. The contact area 224, as illustrated in the examples of the figures, may be ring-shaped. The contact area 224 may be ring-shaped due to many cookwares being bowed concave toward the panel 230. For example, some cookwares may contact the panel 230 without having a center of a bottom of the cookware contacting the panel 230; thus, the contact area 224 may be ring-shaped and centered about the center 210 of the induction burner assembly 202. Therefore, the contact area 224 may be spaced from the center 210 radially. The offset thermistor 216 may be positioned adjacent to the contact area 224 to better sense a temperature of the cookware. Although the contact area 224 is spaced from the center 210 at about half a radius of the induction burner assembly 202, it is to be understood by one of ordinary skill in the art that the contact area 224 may be spaced from the center 210 at any distance that may correspond to a separate radius of a cookware.

Additionally, or alternatively, the offset thermistor 216 may be positioned vertically beneath the panel 230 at the contact area 224 opposite the cookware. In other words, the offset thermistor 216 may be spaced from the contact area 224 by the panel 230. For example, the magnetic field generated by the induction burner assembly 202 heats up the cookware, and in turn the cookware heats the panel 230 at the contact area 224; thus, the offset thermistor 216 may sense the temperature of the panel 230 at the contact area 224 which may more closely resemble the temperature of the cookware compared to elsewhere on the panel 230.

As illustrated, the temperature of the panel 230 may be higher at the contact area 224 as indicated with by the denser hatch. As the panel 230 extends away from the contact area 224, the panel 230 may be cooler in temperature. As illustrated in the example of FIG. 3, the denser hatch may correspond to a high temperature at or about the target temperature of the cookware. The more spread out hatch may represent, for example, a temperature of the panel 230 that is relatively cool. The hatch density may be representative of temperatures between the target temperature of the cookware and, for example, room temperature. The denser hatch may represent, for example, 350 degrees Fahrenheit and the most spread out hatch may represent, for example, 75 degrees Fahrenheit.

The closed-loop control system 200 of the cooking appliance 100 includes a magnetic lead 218 coupled with the offset thermistor 216. The magnetic lead 218 at least partially communicatively couples the controller 162 with the offset thermistor 216. The offset thermistor 216 may be configured to sense a temperature of the panel 230 of the cooktop 102 as it is heated. For instance, offset thermistor 216 may be integrally formed with cooking appliance 100 (e.g., within the cooktop 102). In some embodiments, offset thermistor 216 is operably connected to cooking appliance 100 (e.g., via a port or socket, via a remote connection, etc.). For example, offset thermistor 216 is provided within the cooktop 102 and operably connected to controller 162. Offset thermistor 216 may monitor a temperature of the panel 230 of the cooktop 102 at a location where the offset thermistor 216 is located. Accordingly, offset thermistor 216 may deliver signals (e.g., voltage signals) representing the temperature of the cooktop 102 at the offset thermistor 216 to controller 162.

Additionally, or alternatively, the offset thermistor 216 is configured to sense temperature of the magnetic lead 218. For example, the induction burner assembly 202 may generate the magnetic field, and the magnetic field may heat the magnetic lead 218. As a result, the offset thermistor 216 may sense temperature of the magnetic lead 218. The temperature of the magnetic lead 218 may increase faster than the temperature of the panel 230 due to the magnetic lead 218 being magnetic (e.g., a steel alloy or the like) and the panel being non-magnetic (e.g., glass).

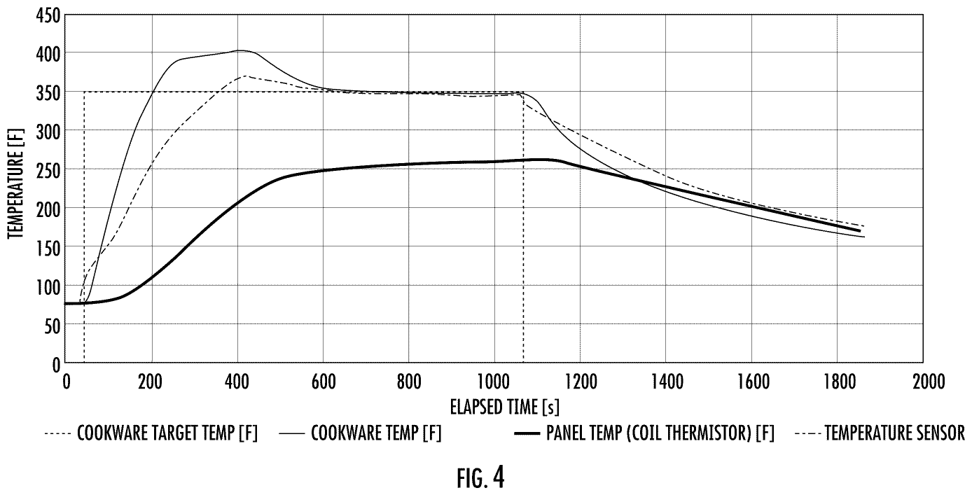

With reference to FIG. 4, allowing the magnetic lead 218 to be heated by the magnetic field of the induction burner assembly 202 allows the offset thermistor 216 to sense a temperature that is closer in value to a temperature of the cookware than a temperature of the panel 230. For example, as illustrated in the graph of FIG. 4, a difference in temperature of measured by the offset thermistor 216 that is heated by the magnetic lead 218 and a temperature of the cookware, or pan, may be less than about 25% of the temperature of the cookware, less than about 20% of the temperature of the cookware, less than about 15% of the temperature of the cookware, or less than about 10% of the temperature of the cookware during about 10 minutes or less of the induction burner assembly 202 being activated. For example, the offset thermistor 216 may sense a temperature of about 300 degrees Fahrenheit at about 6 minutes of the induction burner assembly 202 being activated while the temperature of the cookware is about 400 degrees Fahrenheit at about 6 minutes after the induction burner assembly 202 has been activated. Meanwhile, the panel 230 may be heated to about 150 degrees Fahrenheit at about 6 minutes of the induction burner assembly 202 being activated. Thus, the magnetic lead 218 heating faster than the panel 230 allows the offset thermistor 216 to more accurately estimate the temperature of the cookware compared to merely sensing a temperature of the panel 230 without the magnetic lead 218.

With continued reference to FIG. 4, the magnetic lead 218 may allow the offset thermistor 216 to sense a temperature that is within less than about 5% of the temperature of the cookware after about 10 minutes. Furthermore, after about 10 minutes, the sensed temperature by the offset thermistor 216 may be within less than 5% of a target temperature of the cookware set by the controller 162 and/or the controls 164 (e.g., from user input). Meanwhile, the temperature of the panel 230 may be more than about 25% lower than the target temperature of the cookware even after about 10 minutes. For example, the target temperature may be set to 350 degrees Fahrenheit, the offset thermistor 216 may sense a temperature of about 350 degrees Fahrenheit after about 10 minutes, and the temperature of the panel 230 may level out at about 250 degrees Fahrenheit. Additionally, or alternatively, the offset thermistor 216 may be heated to the target temperature in less than about 7 minutes of the induction burner assembly 202 generating the magnetic field. Comparatively, the panel 230 may not reach the target temperature before operation of the system 200 ceases.

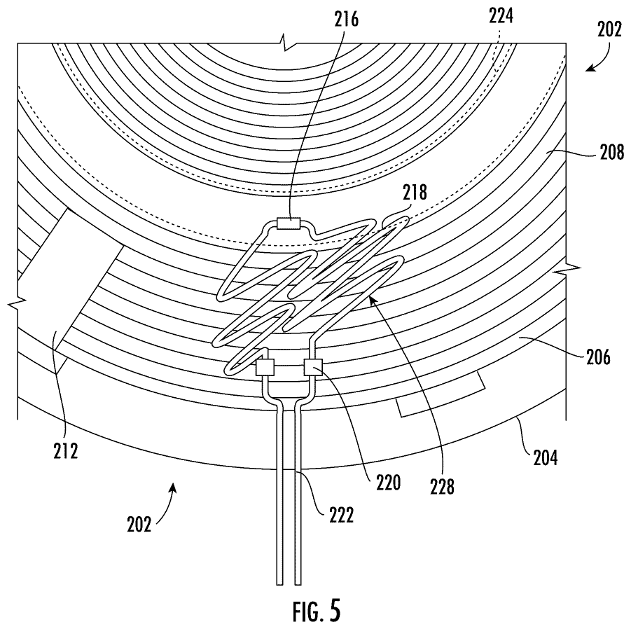

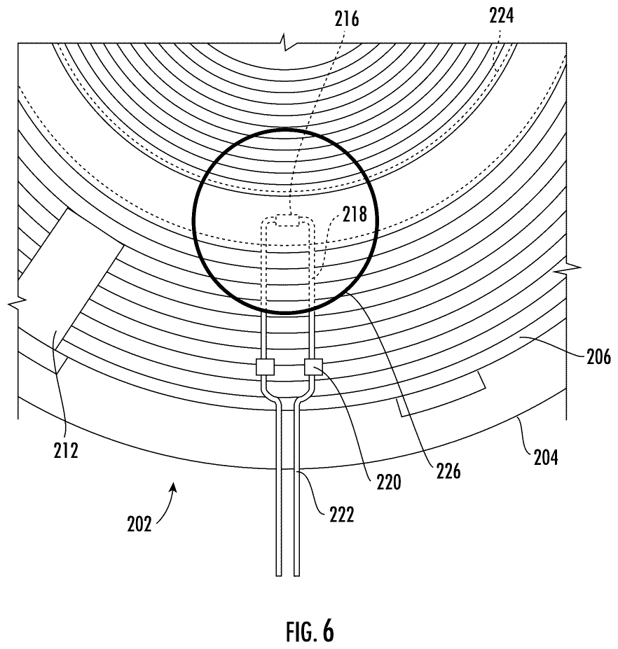

With reference to FIGS. 5 and 6, the closed-loop control system 200 of the cooking appliance 100 may include a surplus of magnetic material adjacent to the offset thermistor 216. The surplus of magnetic material may include a magnetic lead surplus 228. As illustrated in the example of FIG. 5, the magnetic lead surplus 228 may mean that the magnetic lead 218 is nonlinear with extra, or superfluous lead length. The nonlinear magnetic lead surplus 228 may be parabolic, circular, or randomly concentrated around the offset thermistor 216. Additionally, or alternatively, the surplus of magnetic material may include a magnetic feature 226 such as a plate, a washer, a spring, or the like, for example. In this context “surplus” may mean that the surplus of magnetic material contributes to concentrating, or focusing, heat at, or toward, the offset thermistor 216 without necessarily contributing to communicatively coupling the controller 162 with the offset thermistor 216. For example, the more magnetic material there is surrounding, or adjacent to, the offset thermistor 216, the more accurate the offset thermistor 216 will be when sensing temperature that corresponds to a temperature of the cookware. The magnetic material (e.g., the magnetic feature 226 or the magnetic lead 218) may directly contact the offset thermistor 216.

Advantageously, the presently described cooking appliance and closed-loop system described herein allows for the cooking appliance to adjust power directed to an induction burner assembly based on a more accurate temperature sensed by an offset thermistor. The offset thermistor and magnetic material adjacent to the offset thermistor allow for a more accurately sensed temperature of the cookware because the offset thermistor is closer to a contact area and the offset thermistor is heated by the magnetic material. Furthermore, the system described herein may allow for the offset thermistor to detect a temperature that is close enough to a cookware temperature such that the system may not need to use complex statistical regression analysis, or other formulaic estimation methods, to operate the system based on the cookware temperature.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance defining a transverse direction, a lateral direction, and a vertical direction, comprising:
an induction burner assembly having a center, wherein the induction burner assembly generates a magnetic field;
an offset thermistor positioned within the magnetic field generated by the induction burner assembly, wherein the offset thermistor is positioned radially offset from the center of the induction burner assembly;
a magnetic lead coupled with the offset thermistor, wherein the magnetic lead is heated by the magnetic field generated by the induction burner assembly, and wherein the magnetic lead heated by the magnetic field heats the offset thermistor; and
a controller communicatively coupled with the induction burner assembly and the thermistor, wherein the magnetic lead allows the controller to be communicatively coupled with the offset thermistor.

2. The cooking appliance of claim 1 further comprising a cooktop having a panel positioned vertically above the thermistor, wherein the panel is configured to support a cookware.

3. The cooking appliance of claim 2, wherein the panel has a contact area configured to be contacted by the cookware, and wherein the offset thermistor is spaced vertically from the contact area by the panel.

4. The cooking appliance of claim 3, wherein the contact area is spaced from the center of the induction burner assembly.

5. The cooking appliance of claim 1 further comprising surplus magnetic lead coupled with and extending between the offset thermistor and the magnetic lead, wherein the surplus magnetic lead focus heat toward the offset thermistor.

6. The cooking appliance of claim 5, wherein the surplus magnetic lead is nonlinear.

7. The cooking appliance of claim 1 further comprising:
a crimp coupled with the magnetic lead; and
a nonmagnetic lead coupled with the crimp, wherein the nonmagnetic lead communicatively couples the controller with the offset thermistor.

8. The cooking appliance of claim 1 further comprising a magnetic feature coupled with the offset thermistor, wherein the magnetic feature is heated by the magnetic field generated by the induction burner assembly, and wherein magnetic feature heated by the induction burner assembly heats the offset thermistor.

9. The cooking appliance of claim 1 further comprising a center thermistor positioned at the center of the induction burner assembly, wherein the center thermistor comprises center thermistor leads that are positioned away from the magnetic field generated by the induction burner assembly.

10. The cooking appliance of claim 1, wherein the controller is configured to activate the induction burner assembly to generate the magnetic field, wherein the magnetic field is configured to heat a cookware to a target temperature, and wherein the offset thermistor is heated to the target temperature in fewer than about 7 minutes.

11. A closed-loop control system for a cooking appliance defining a transverse direction, a lateral direction, and a vertical direction, the closed-loop control system comprising:
an induction burner assembly having a center, wherein the induction burner assembly generates a magnetic field;
an offset thermistor positioned within the magnetic field generated by the induction burner assembly, wherein the offset thermistor is positioned radially offset from the center of the induction burner assembly;
a magnetic lead coupled with the offset thermistor, wherein the magnetic lead is heated by the magnetic field generated by the induction burner assembly, and wherein the magnetic lead heated by the magnetic field heats the offset thermistor; and
a controller communicatively coupled with the induction burner assembly and the offset thermistor, wherein the magnetic lead allows the controller to be communicatively coupled with the offset thermistor, and wherein the controller is configured to:
activate the induction burner assembly; and
direct power to the induction burner assembly based on a temperature sensed by the offset thermistor.

12. The system of claim 11 further comprising a cooktop having a panel positioned vertically above the offset thermistor, wherein the panel is configured to support a cookware.

13. The system of claim 12, wherein the panel has a contact area configured to be contacted by the cookware, and wherein the offset thermistor is spaced vertically from the contact area by the panel.

14. The system of claim 13, wherein the contact area is spaced from the center of the induction burner assembly.

15. The system of claim 11 further comprising surplus magnetic lead coupled with and extending between the offset thermistor and the magnetic lead, wherein the surplus magnetic lead focus heat toward the offset thermistor.

16. The system of claim 15, wherein the surplus magnetic lead is nonlinear.

17. The system of claim 11 further comprising:
a crimp coupled with the magnetic lead; and
a nonmagnetic lead coupled with the crimp, wherein the nonmagnetic lead communicatively couples with controller with the offset thermistor.

18. The system of claim 11 further comprising a magnetic feature coupled with the offset thermistor, wherein the magnetic feature is heated by the magnetic field generated by the induction burner assembly, and wherein magnetic feature heated by the induction burner assembly heats the offset thermistor.

19. The system of claim 11 further comprising a center thermistor positioned at the center of the induction burner assembly, wherein the center thermistor comprises center thermistor leads that are positioned away from the magnetic field generated by the induction burner assembly.

20. The system of claim 11, wherein the magnetic field is configured to heat a cookware to a target temperature, and wherein the offset thermistor is heated to the target temperature in fewer than about 7 minutes.
